(19) United States
(12) Patent Application Publication
(10) Pub. No.: US 2020/0085682 A1
(43) Pub. Date: Mar. 19, 2020

(54) PAD FOR PROVIDING A CARDIAC MASSAGE

(71) Applicant: Progetti S.r.l., Trofarello (TO) (IT)

(72) Inventors: Maurizio SANTOMAURO, Napoli (IT); Nicola GIULIETTI, Chiusi (SI) (IT); Eugenio FOSSAT, Pinerolo (TO) (IT)

(21) Appl. No.: 16/571,569

(22) Filed: Sep. 16, 2019

(30) Foreign Application Priority Data
Sep. 18, 2018 (IT) 102018000008691

(51) Int. Cl. A61H 31/00

(52) U.S. Cl. CPC A61H 31/005; A61H 31/007; A61H 2201/018; A61H 2201/1619; A61H 2201/5043; A61H 2201/5061; A61H 2201/169

(57) ABSTRACT

Described herein is a pad for administering a cardiac massage, including: a first layer configured for being applied on the chest of a patient; and a second layer coupled to said first layer, the second layer being configured for receiving an action by an operator administering the cardiac massage, where said first layer is made of a material having an average value of the transmitted force, in an impact test at ambient conditions according to EN1621-1 at an energy of 10 J, lower than 25 kN.

### FIELD OF THE INVENTION

The present invention relates to aids for cardiac massage, in particular to pads to be used as aid devices for cardiac massage.

### PRIOR ART

The onset of internal lesions during administration of a cardiac massage to adult subjects is a widely known circumstance. Some estimates indicate that one patient out of three undergoes at least one fracture of the ribs, and at least one patient out of five undergoes a fracture of the sternum. Further studies even suggest a considerably higher incidence.

One of the most frequent causes of the aforementioned internal lesions corresponds to wrong positioning of the hands of the rescuer (or of the pressure element in the case of cardiac massage conducted using machines).

In the case where the area of application of the force is too high on the chest (i.e., towards the neck of the patient) or too lateral with respect to the sternum, the risk of rib fractures increases.

In the case where the area of application of the force is too low (i.e., close to the abdomen), this increases considerably the risk of producing intra-abdominal lesions.

It is estimated that a correct application of the force during administration of a cardiac massage reduces rib fractures in approximately one fifth of cases.

Various factors may have an effect on correct positioning of the area of application of the force. Amongst these factors there may be, inter alia, the action of disturbance induced by the movement of the first-aid vehicle which is transporting the patient and on board which the cardiac massage is being administered, a circumstance on the other hand aggravated by the need for fast changes of the operators engaged in administering the massage to enable them to recover their forces.

According to the AHA (American Heart Association) guidelines and the ERC (European Resuscitation Council) guidelines for CPR (Cardiopulmonary Resuscitation), cardiac massage should be administered with a frequency comprised between one hundred (100) and one hundred and twenty (120) times per minute with a compression depth of 50-60 mm (i.e., the sternum of the patient must be depressed by between 50 mm and 60 mm with respect to the condition at rest in order to stimulate pumping of blood towards the brain).

The compression must be followed by a release step in order to enable the sternum to recover the position elastically and allow return of the blood towards the chest. The duration of the step of release should ideally be equal to the duration of the step of compression.

From the sum of the prescriptions referred to above, it follows that the compression step should have a maximum duration of 0.3 s, which is a very restricted time for guaranteeing precision and repeatability. It is therefore likely that the rescuer will apply impulsive forces in the attempt to maintain the required frequency of administration, with consequent increase in the risk of internal lesions. Clearly, the combination of an action on the part of the rescuer that is in any case not ideal, and of a movement of the rescue vehicle (with sharp accelerations) during treatment of the subject further increases the risk of internal lesions.

A further factor that can increase the incidence of internal lesions is the distribution of the pressure exerted during the cardiac massage. An excessively small area of compression increases considerably the risk of lesions. It is, however, important not to exaggerate: a simulation of a FEM (finite-element model) type on the effects of thoracic compression reveals that a circular area compression with a diameter of approximately 80 mm could reduce, as compared to solutions of larger dimensions, the stress on the sternum and on the ribs.

### OBJECT OF THE INVENTION

The object of the present invention is to solve the technical problems mentioned previously. In particular, the object of the invention is to provide a pad to be used as aid in cardiac massage that will drastically reduce the incidence of rib or abdominal lesions in the patient.

### SUMMARY OF THE INVENTION

The object of the present invention is achieved by a pad having the characteristics forming the subject of the ensuing claims, which constitute an integral part of the technical teaching provided herein in relation to the invention.

### BRIEF DESCRIPTION OF THE DRAWINGS

The invention will be now described with reference to the annexed drawings, which are provided purely by way of non-limiting example and in which:

FIG. 1 is a perspective view of a pad according to a preferred embodiment of the invention;

FIG. 2 is an exploded perspective view of the pad of FIG. 1;

FIG. 3 is a cross-sectional view according to the trace III-III of FIG. 1;

FIG. 4 is a perspective view of a pad according to a further embodiment of the invention; and

FIG. 5 is an exploded perspective view of the pad of FIG. 4.

### DETAILED DESCRIPTION

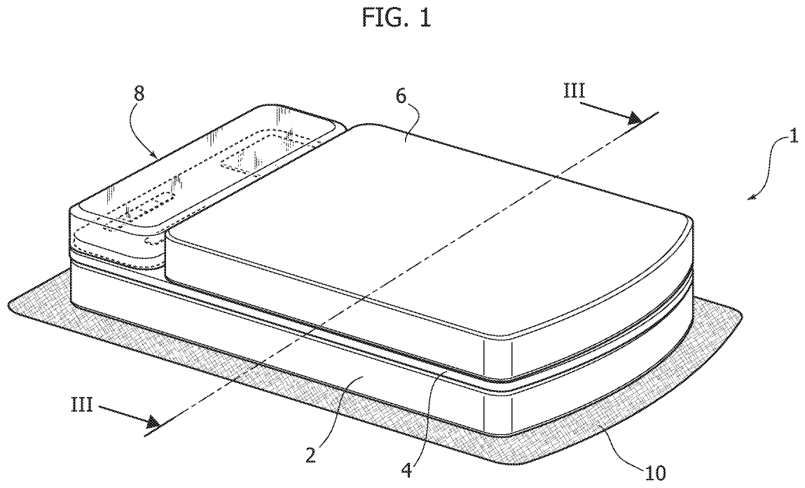

The reference number 1 in FIG. 1 designates as a whole a pad for administering a cardiac massage according to a preferred embodiment of the invention.

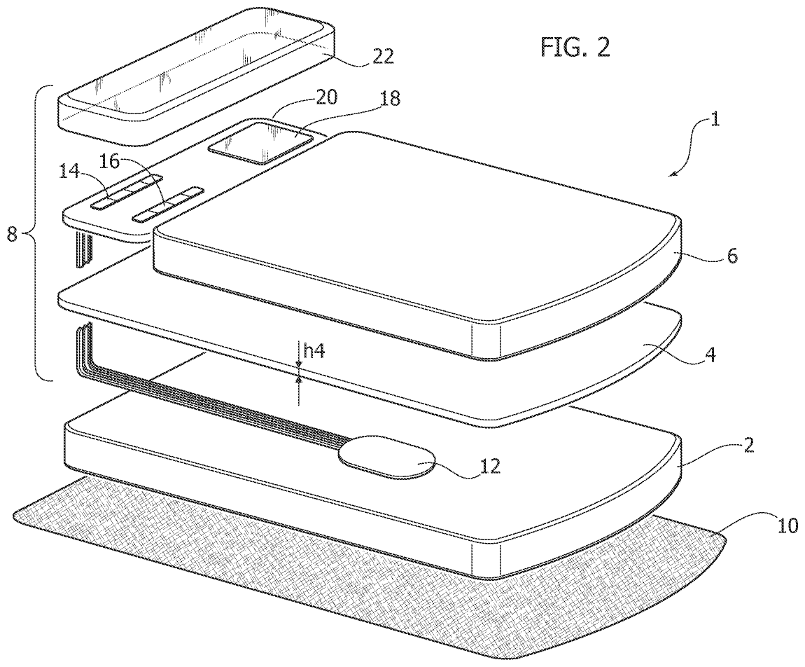

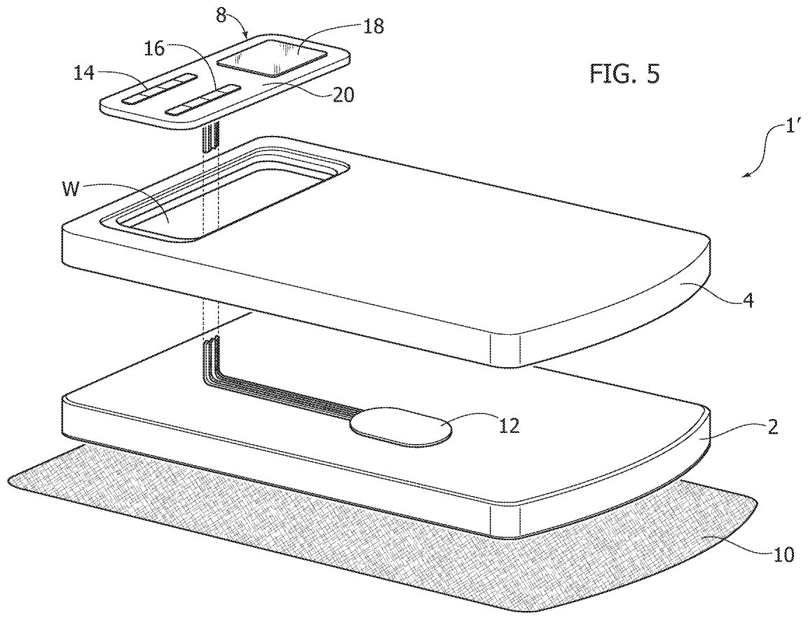

With reference to FIGS. 1 to 3, the pad 1 includes a first layer 2, a second layer 4, a third layer 6, and a monitoring unit 8. The layer 4 is set between the layers 2 and 6, even though the latter, albeit preferable, is in itself optional. An embodiment without the layer 6 is represented in FIGS. 4 and 5 and is designated by the reference 1′. The ensuing description, except where it regards the layer 6, or else where otherwise specified, applies both to the pad 1 and to the pad 1′.

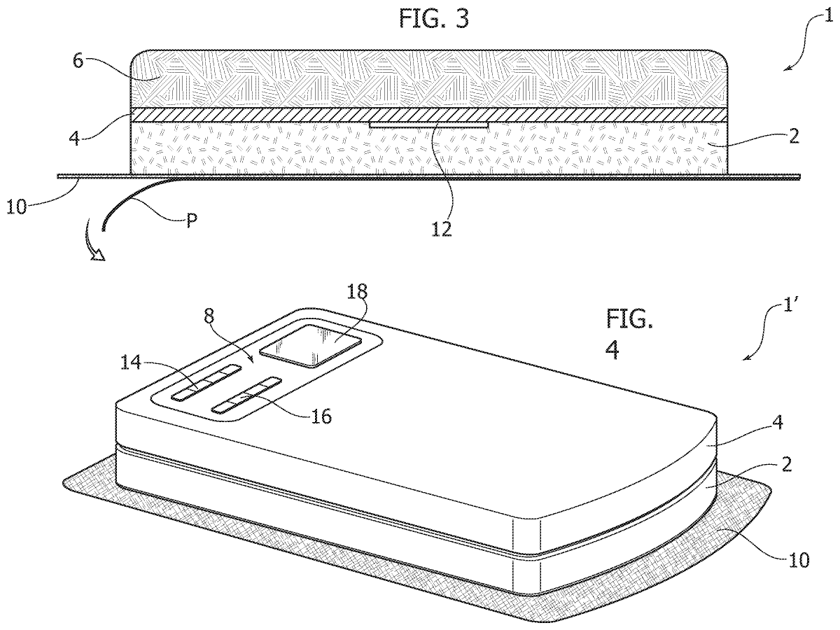

The first layer 2 is configured for being applied on the chest of a patient, meaning thereby that, at the moment of administration of the cardiac massage, it constitutes the element downstream of the chain of transmission of the action of the rescuer. Preferably, fixed on a surface of the layer 2 opposite to that of interface with the layer 4 is an adhesive patch 10, for example a sterile gauze with adhesive layer, which at the moment of administration of the cardiac massage is configured for enabling the layer 2 (and the pad 1 as a whole) to adhere to the chest of the patient. With reference to FIG. 3, preferably the adhesive layer is coated by an anti-adherent film P to preserve it up to use thereof. The adhesive patch 10 considerably facilitates the activity of the rescuer in so far as adhesive fixing of the pad 1 on the chest of the patient enables—once the optimal area for application of the force is identified—to maintain the action in said area preventing the risk of jerks, which is a potential cause of lesions.

In order to reduce the incidence of rib and abdominal lesions, the first layer 2 is made of a material that has an average value of the transmitted force, during an impact test in ambient conditions according to EN1621-1:2013 (Ambient impact test) with an impact energy of 10 J, of less than 25 kN.

More preferably, the material is chosen so that it has an average value of the transmitted force of less than 15 kN, and even more preferably of less than 7 kN.

The ambient impact test described in the EN1621-1 standard has been developed in order to test protective garments against mechanical impact for motor cyclists, but is commonly used also to characterise materials capable of attenuating impacts in the absence of another specific standard; the standard EN1621-1 prescribes an impact energy of 50 J. However, the test can be conducted with the same apparatus, even choosing different impact energies, for example, reducing the dropping height of the percussion device (the so-called “drop striker”): in particular, the test conducted at 10 J is more consistent with the conditions that may be encountered during cardiac massage.

According to the invention, it is moreover preferable for the material of the layer 2 to feature one or more, or preferably all, of the following properties:
density comprised between 60 and 800 kg/m³, preferably between 80 and 550 kg/m³, even more preferably between 100 and 400 kg/m³;
thickness comprised between 0.4 cm and 3 cm, preferably between 0.6 and 2 cm, and even more preferably between 0.7 and 1.5 cm;
hardness comprised between 30 and 98 Durometer type 00 (ASTM D2240-00), more preferably between 40 and 90 Durometer type 00 (ASTM D2240-00);
rebound height according to ASTM D3574-08—Test H (Flexible cellular polymeric materials—Determination of the resilience by means of the rebound of a ball) lower than 15 cm, more preferably lower than 10 cm, and even more preferably lower than 5 cm; and
recovery time according to ASTM D3574-08—Test M (Recovery time) lower than 1.5 s, more preferably lower than 1 s, and even more preferably lower than 0.6 s; the lowest values of recovery time are optimal for each compression to be able to start with the layer 2 in substantially “neutral” conditions, or in any case conditioned to a minimal extent by the previous compression-release cycle.

Each of these properties has an effect on a specific aspect of the interaction between the layer 2 and the patient.

A hardness in the range referred to above renders the interaction with the skin of the patient gentler (even though this occurs through the patch 10, where this is provided), and in particular prevents skin abrasions and/or lesions and reduces the stresses on projecting bones and cartilages. An excessively high or low hardness can in fact produce a far from uniform distribution of the force exerted on the pad, concentrating the pressure on projecting areas of the chest (for example, the ribs) in the case of excessive hardness, or else on the area corresponding to part of the palm of the hand (e.g., thenar eminence) of the rescuer in the case of insufficient hardness.

The aforementioned rebound height is indicative of the capacity of the material of the layer 2 to absorb the kinetic energy and distribute it inside itself.

Last, but not least, the recovery time is indicative of the speed of the material to recover its undeformed condition. This is a very important aspect for the type of application in so far as excessively long recovery times nullify the optimal conditions for transmission of the force at the interface between the layer 2 and the chest of the patient. In particular, a recovery time that falls outside the range according to the present invention could result in an interface between the layer 2 and the chest of the patient that does not recover deformation to a sufficient extent during release after the action of compression and that in this way is unsuitable to absorbing and attenuating the impulsive energy of the next compression.

A class of materials that satisfies the constraints referred to above is that of so-called cellular rubbers.

Various commercial cellular rubbers that meet the above requisites are currently available, for example, the ones known by the following trade names:
D3O® Set Foams (ST, XT, Shock+, Decell, Pulse, and Aero), marketed by the company D3O Lab (UK);
ARTi-LAGE Super Hero Foams, marketed by ARTi-LAGE (USA);
Poron® and Poron® XRD®, marketed by Rogers Corporation (USA);
OrthoLite® foams, marketed by O2 Partners LLC (USA); and
Polyanswer foams, marketed by POSSIBLE ANSWER S.A. (Portugal).

These materials enable dissipation, accumulation, and/or redistribution in time of the kinetic energy applied by the rescuer in the case where it is applied in an excessively short time, which is equivalent to the duration of a violent impact. On the other hand, the momentum and the force applied by the rescuer is transmitted by the material to the body of the patient according to the laws of dynamics (conservation of momentum and principle of action and reaction), without adversely affecting the depth of the compressions.

The layer 2 preferably determines also the dimensions of the pad 1 and must take into account the dimensional considerations mentioned at the outset of the present description. Since in cardiac massage performed manually the area subjected to the highest pressure has a length comprised between 92 and 65 mm measured along the sternum, the length of the pad 1 (to be oriented along the principal direction of the sternum) should be greater than 92 mm, more preferably comprised between 100 mm and 180 mm, also in order to enable resting of the palm of the rescuer's hand thereon.

The sternum, on the other hand, has a width generally comprised between 29 and 47 mm (I. M. G. Pedersen, J. J. Hermans, J. F. M. Molenbroek, “Measurements of the sternum for better cardiopulmonary resuscitation”). Consequently, it is convenient for the pad 1—in order to distribute the force over the lower half of the sternum according to the guidelines mentioned at the outset of the present description—to have a width of at least 38 mm, preferably at least 47 mm, and more preferably between 47 and 100 mm, also in order to facilitate cardiac massage by the rescuer.

The second layer 4 is configured for receiving an action by an operator who administers the cardiac massage, both directly and via the layer 6, and is configured for distributing this action on the interface with the first layer 2. In this sense, the action of the second layer 4 comes to add to the natural capacity of internal distribution of the forces that characterises the layer 2. For this purpose, the layer 4 is made of relatively rigid material, and in particular presents properties of flexural rigidity higher than those of the layer 2.

The layer 4 has dimensions in plan view comparable to the layer 2 (so that it can be conveniently accommodated on top of the latter).

The flexural rigidity of the layer 4 is directly proportional to the product E₄·h₄³, where E₄ is the flexural elasticity modulus of the layer 4, determined, for example, according to ASTM D790 at 25° C., while h₄ is the thickness of the layer 4. According to the invention, for the layer 4 to be able to distribute the force applied effectively, the product E₄·h₄³ must be at least higher than 0.8 N·m, preferably higher than 4 N·m, even more preferably higher than 8 N·m.

The layer 6 is preferentially made of a material similar or identical to that of the layer 4, and with properties in the same ranges listed for the layer 4.

In a preferred embodiment, the layer 6 has a recovery time according to ASTM D3574-08—Test M shorter than the recovery time according to ASTM D3574-08—Test M of the layer 2. The recovery time of the layer 6 is hence preferably circumscribed to the two narrowest ranges from among the ones listed above for the layer 2, preferably shorter than 1 s, and even more preferably shorter than 0.6 s.

Reducing the recovery time of the layer 4 enables the latter to recover the undeformed condition even faster: this is important because—if so desired—from this standpoint the layer 6 operates in more burdensome conditions. For the layer 2 the effects of just a partial recovery of shape are in part mitigated by the more extensive surface of application of the force (thanks to the action exerted by the layer 4 that renders the pressures uniform). Instead, the force exerted by the hands of the operator on the layer 6 is concentrated in some areas of the palm, under which the layer undergoes a greater deformation that has to be recovered in time to dampen the subsequent compression.

The monitoring unit 8 further comprises one or more force sensors 12 arranged between the first layer 2 and the second layer 4, where the force sensors 12 are operatively connected to one or more status indicators 14, 16, 18, which are housed in the pad 1. In the embodiment illustrated herein, the status indicators 14, 16, 18 are provided on a substrate 20 (for example, made of Vetronite and possibly including one or more printed circuits for electrical connection between sensor/sensors and status indicators), but it is conveniently possible to provide the status indicators 14, 16, 18 on the layer 4, which could itself be made of a material suitable for a printed circuit (Vetronite). Alternatively, the substrate 20 can be directly embedded within the layer 4, as may be seen in the pad 1′ of FIGS. 4 and 5, which purposely include a seat W for the substrate 20.

Conveniently, in the pad 1 the monitoring unit 8 is protected by means of a canopy 22, which can be rendered removable for gaining access to a battery compartment (for battery replacement).

In a preferred embodiment, the status indicators comprise:
an indicator of force applied or of depth of the massage 14;
an indicator of frequency of administration of the massage 16; and optionally
a screen 18 for displaying the instantaneous data of force/depth and of frequency of administration of the cardiac massage.

Moreover, the sensor kit can be integrated by an accelerometer.

The one or more force sensors 12, and possibly the accelerometer, are operatively connected to a microprocessor or in general to a control unit that interacts with the status indicators 14, 16, 18 so as to send the desired information to the operator who is administering the treatment. Preferably, the indicator of force/depth of the massage 14 and the indicator of frequency of administration 16 are provided as bands of light sources (for example, LEDs) that cover a range of different colours associated to different intensities of the respective quantity being monitored (for example, a range from green to red).

The control unit is preferably equipped with an internal clock, and by calculating the time that elapses between the two steps of application of the force by the operator (and more in detail, for example, between the peak of application of the force of each compression) shows the operator, via the status indicators, whether the frequency of administration of the massage is correct, or else excessively high or low.

The depth of the massage possibly indicated by the status indicators, is calculated by the control unit by means of an algorithm that employs empirical or analytical relations between the average depth of the massage and the force applied (which is in turn calculated on the basis of the force acting on the force sensors) and/or uses the displacement of the pad calculated by means of the data obtained from the accelerometer, if this is present. Various methods are known for obtaining the displacement from measurements of acceleration; in particular, it is possible to interpolate the data supplied by the accelerometer and calculate the displacement by means of a double operation of integration with respect to time. Since the readings of the accelerometer are discrete in time and affected by error, the displacement thus obtained will also be affected by error (including systematic error) that could accumulate in time on account of the operation of integration; the data supplied by the force sensor enable correction of the aforesaid error and prevent accumulation thereof, also using empirical relations: for example, after a certain time in the absence of application of force (step of release) the chest will return on average into the situation at rest, and the displacement may be considered equal to zero. The algorithm used by the control unit for calculation of the depth of the massage takes into account also the compression undergone by the first layer 2 of the pad, set between the accelerometer and the chest, deformation of which by compression (which is experimentally known for each value of the force applied to the pad) will be subtracted from the value of displacement calculated as described previously, in order to calculate the exact displacement undergone by the surface of the chest.

In an alternative embodiment, the sensor kit comprises just the accelerometer, through which the control unit determines the frequency of cardiac massage (analysing the plot of the accelerations produced by the force applied by the operator) and the depth thereof according to the modalities already described.

At the moment of administration of a cardiac massage, the pads 1, 1′ can be used by the rescuer as aid to administration. The patch 10—which is, in itself, a disposable component that is replaced at each new use of the pad—is provided with a removable film that protects the layer of adhesive on the surface that is to come into contact with the chest of the patient. The rescuer removes the protective film and, once he has identified the optimal area of application of the pad 1 on the chest of the patient, he applies the pad, which firmly adheres thanks to the adhesive present on the patch 10. In order to guarantee maximum hygiene of the pad, this may be entirely or partially enclosed by a protective wrapper, preferably constituted by a thin layer of elastomer or of elasticised synthetic fabric, which can be replaced after use; in this case, the patch may be attached to said coating layer or replaced thereby.

Once the monitoring unit 8, if present, is switched on, the rescuer starts administration of the cardiac massage. At this point the advantages afforded by each of the layers of the pad 1 converge, which are namely the following.

i) The layer 2 has characteristics such as to dissipate impulsive forces and impacts in an efficient way, and to attenuate, undergoing deformation, possible undesired horizontal thrusts. Moreover, together with the other layers, it contributes to a more uniform distribution of the thrusts exerted during cardiac massage.

ii) The possible layer 6 contributes, together with the layer 2, to the dissipation of the energy linked to impulsive forces and impacts, and to attenuation, by undergoing deformation, of possible undesired horizontal thrusts. Moreover, it improves the comfort for the hands of the rescuer who is administering the cardiac massage.

In fact, the rescuer administering the massage may suffer, during the operation, lesions to the hands and above all to the skin of the hands. This illustrates a risk factor in the case where the hands of the rescuer come into contact with infected blood, in addition to arousing a condition of discomfort that may distract the rescuer in his work.

In this sense, it is important for the layer 6 to exhibit also properties of resistance to tearing in order to prevent gradual degradation thereof (which might constitute the source of further injury to the hands of the rescuer) as the massage proceeds. In particular, it is preferable for the layer 6 to present resistance to tearing, measured according to the standard ASTM D624, higher than 0.35 kN/m.

iii) The layer 4 evens out and distributes the pressure on the layer 2, which in turn transfers the action to the chest.

iv) Numerous studies report that the majority of the compressions exerted during cardiac massage are too weak and tend progressively to diminish in intensity with the increase in tiredness of the rescuer, thus causing a potential failure of the rescue procedure.

The one or more force sensors 12 help the rescuer to exert a force commensurate with the needs. In particular, if the pressure exerted on a portion of surface of the layer 2 is known, it is possible to establish to a good approximation the force exerted during the cardiac massage on the rigid layer 4. To improve reliability and precision of the system it is possible to resort to a number of force sensors 12, arranged in different areas of the interface between the layers 2 and 4. There exist on the market different types of sensors designed for the purpose. In particular, FSR (Force-Sensitive Resistor) thin-film technology is inexpensive and reliable; these sensors vary their own electrical resistance as a function of the pressure applied.

v) In the case where also an accelerometer were provided, it would be possible to evaluate—for the benefit of the rescuer—also the depth of the massage, which should be of at least 50 mm; however, it should be borne in mind that, if the patient to be re-animated is not laid down on a rigid support, the reading of the accelerometer will be wrong in so far as it will detect the bending of the support together with the movement of the chest of the patient. This corresponds to the circumstance where the person is lying on a mattress or on a stretcher: in this case, the accelerometer overestimates by 35-40% the effective depth of the massage. The use of force sensors prevents this problem since it affords a natural check on consistency for the data coming from the accelerometer. On the other hand, the capacity of the layer 2 to prevent sharp variations of acceleration, which are difficult to measure, improves the reliability of the data recorded by the accelerometer, enabling the control unit to make a correct evaluation of the displacement, drawing on the latter data and on the ones supplied by the force sensor.

vi) Lastly, adhesion of the pad 1, 1′ on the chest of the patient through the patch 10 eliminates the risks of shifting of the action, and consequently removes one of the most serious causes of injury to the patient.

Of course, the details of construction and the embodiments may vary widely with respect to what is described and illustrated herein, without thereby departing from the scope of the present invention, as defined by the annexed claims.

1. A pad for administering a cardiac massage, comprising:
a first layer configured for being applied on a chest of a patient; and
a second layer coupled to said first layer, the second layer being configured for receiving an action by an operator administering the cardiac massage,
wherein:
said first layer is made of a material having an average value of a transmitted force, in an impact test at ambient conditions according to EN1621-1 at an energy of 10 J, lower than 25 kN.

2. The pad according to claim 1, wherein the material of the first layer has an average value of the transmitted force, in the impact test at ambient conditions according to EN1621-1 at the energy of 10 J, lower than 15 kN.

3. The pad according to claim 1, wherein the material of the first layer has at least one of the following features:
hardness comprised between 30 and 98 Durometer Type OO (ASTM D2240-00),
rebound height according to ASTM D3574-08—Test H lower than 15 cm, and
recovery time according to ASTM D3574-08—Test M lower than 1.5 s.

4. The pad according to claim 1, wherein said first layer has a density comprised between 60 and 800 kg/m³.

5. The pad according to claim 1, wherein said first layer has a thickness comprised between 0.4 cm and 3 cm.

6. The pad according to claim 1, wherein said first layer has a hardness comprised between 40 and 80 Durometer type OO (ASTM D2240-00).

7. The pad according to claim 1, wherein said first layer has a rebound height according to ASTM D3574-08—Test H lower than 10 cm.

8. The pad according to claim 1, further comprising a third layer coupled to said second layer, said second layer being arranged between said first layer and said third layer, said third layer being configured for receiving the action of the operator administering the cardiac massage.

9. The pad according to claim 8, wherein said third layer has a recovery time according to ASTM D3574-08—Test M lower than 1 s.

10. The pad according to claim 1, further comprising one or more force sensors arranged at an interface between said first layer and said second layer, said one or more force sensors being operatively connected to one or more status indicators of said pad.

11. The pad according to claim 10, wherein said one or more status indicators comprise:
an indicator of applied force or of depth of the massage; and
an indicator of frequency of administration of the massage.

12. The pad according to claim 1, wherein for said second layer a product E₄·h₄³ is higher than 0.8 N·m, and
where:
E₄ is a flexural elasticity modulus of the second layer according to ASTM D790 at 25 C; and
h₄ is a thickness of the second layer.

13. The pad according to claim 1, wherein the material of the first layer has an average value of the transmitted force, in the impact test at ambient conditions according to EN1621-1 at the energy of 10 J, lower than 7 kN.

14. The pad according to claim 1, wherein said first layer has a density comprised between 80 and 550 kg/m³.

15. The pad according to claim 1, wherein said first layer has a density comprised between 100 and 400 kg/m³.

16. The pad according to claim 1, wherein said first layer has a thickness comprised between 0.7 cm and 1.5 cm.

17. The pad according to claim 1, wherein said first layer has a rebound height according to ASTM D3574-08—Test H lower than 5 cm.

18. The pad according to claim 8, wherein said third layer has a recovery time according to ASTM D3574-08—Test M lower than 0.6 s.

19. The pad according to claim 1, wherein for said second layer a product E₄·h₄³ is higher than 4 N·m,
where:
E₄ is a flexural elasticity modulus of the second layer according to ASTM D790 at 25 C; and
h₄ is a thickness of the second layer.

20. The pad according to claim 1, wherein for said second layer a product E₄·h₄³ is higher than 8 N·m,
where:
E₄ is a flexural elasticity modulus of the second layer according to ASTM D790 at 25 C; and
h₄ is a thickness of the second layer.
